(19) United States
(12) Patent Application Publication
(10) Pub. No.: US 2008/0264107 A1
(43) Pub. Date: Oct. 30, 2008

(54) Methods and Process of Tapering Waveguides and of Forming Optimized Waveguide Structures

(76) Inventors: Yacov Malinovich, Tivon (IL); Eli Arad, Petach Tikva (IL); Amotz Shemi, Herzliya (IL); Eyal Porat, Givat-Ella (IL); Rodi Grimberg, Kfar Saba (IL)

Correspondence Address: Pearl Cohen Zedek Latzer, LLP, 1500 Broadway, 12th Floor, New York, NY, 10036, US

(21) Appl. No.: 11/667,833

(22) PCT Filed: Nov. 17, 2005
(86) PCT No.: PCT/IL05/01223

§ 371 Date: Apr. 3, 2008

Related U.S. Application Data
(60) Provisional application No. 60/628,138, filed on Nov. 17, 2004.

(51) Int. Cl. C03B 37/01; C03B 37/022

(52) U.S. Cl. 65/425; 65/491

(57) ABSTRACT

In some embodiments of the present invention, an electrical field is applied across a waveguide substrate so as to induce ion exchange process that affects the cross section of the waveguide. Shaped electrical field may, according to the invention, may control the size and shape of the waveguide along it.

### BACKGROUND OF THE INVENTION

Recently, as wavelength division multiplexing (WDM) optical communication systems are employed, demand for optical devices used in the WDM optical communication systems has been significantly increased. Optical fiber is usually used as a transfer path of optical signals on optical communications. However, there is a technical limit in manufacturing the fiber device having multi-channel such as a multi-channel optical coupler and WDM device. Therefore, a planar light waveguide circuit (PLC), where optical waveguides and many unit optical devices are integrated, is used in WDM devices.

Optical communication systems are configured to propagate signals between various locations. Through at least a portion of such a communication system, the signals are provided as light that is propagated along an optical path.

At various locations along an optical path of a communication system, it may be desirable to reshape or scale the mode of light propagating along the optical path. For instance, mode typically is reshaped to satisfy mode-match requirements of optical components positioned along an optical path. For example, mode may be reshaped to accommodate a transition from an optical fiber to an integrated optic component. As used herein, the term “mode” refers to the spatial distribution of light relative to a cross-sectional area oriented normal to the optical path. To couple efficiently, the waveguide used for coupling should be relatively lossless and remain a single mode waveguide despite the change in its channel width between the two dimensions. The latter consideration requires that the index of refraction along the channel vary inversely with the change in its geometry. These factors pose problems.

In particular, if the desired change in channel width is achieved simply by forming, by the normal photolithographic techniques, a channel whose width tapers gradually between the two dimensions needed, the index of refraction of the channel guide tends to remain uniform along the length of the tapered region because the concentration of the impurity added to form the index of refraction change in the channel tends to be uniform along such length. As a consequence, because the width of the channel varies along such length while the index of refraction remains uniform along the length, the modal properties along the region of taper vary. What is needed to maintain the modal properties essentially constant along the length where the channel width varies is a compensating change in the index of refraction along such length. The problem is especially critical with waveguides that use a large index of refraction change between the channel and its substrate to achieve tight confinement of energy in the channel. The large index change results in a large modal mismatch between the relatively narrow single mode channel waveguides useful in integrated circuit devices and the typically wider optical fibers that are often coupled to such channel waveguides.

Transformation of modal properties through axial tapering of a waveguide is useful in several contexts. For example, mode-size transformation permits independent optimization of the mode size in different portions of the waveguide for effective input and output coupling. Mode-size transformation also can be used to obtain a narrow far-field of the out coupled modes. An adiabatic taper from a single-mode to a multi-mode waveguide also permits robust coupling into the fundamental mode of a multi-mode waveguide. This is important in certain types of nonlinear waveguide devices that involve interactions between modes at widely separated wavelengths.

A prior art solution for mode matching uses an optical fiber and a micro-lens, e.g., a spherical lens or gradient index lens. The optical fiber and micro-lens allow for collection of light from the output component, e.g., an output fiber. The optical fiber and micro-lens also provide input coupling of light into the input component, e.g., an input fiber. Typical disadvantages of using such a solution include design difficulties in providing components that are configured to receive the input mode and provide an appropriately reshaped output mode.

Tapered optical fibers also have been used to reshape mode. A tapered optical fiber includes one or more tapered portions, i.e., portions that have cross-sectional areas that vary along their respective lengths. The tapered portions of these fibers typically are formed by controlled incremental heating. For instance, by heating a portion of a fiber, the fiber core tends to expand, thus resulting in a localized increase in cross-sectional area of the fiber. Simultaneous heating and pulling of the fiber results in a reduction of cladding and core dimensions. A potential disadvantage of using tapered optical fibers includes decreased mechanical strength of the fiber.

Additionally, integrated optic waveguides with continuous tapers and segmented tapers have been used for reshaping mode. As used herein, the term “segmented taper” refers to a waveguide taper that is composed of or divided into portions with different optical properties that are defined by dielectric boundaries. These dielectric boundaries are formed between the waveguide portions and portions of the substrate material, as viewed along the axis of light propagation. The term “continuous taper” refers to a waveguide taper in which light, upon its propagation, does not traverse dielectric boundaries between the waveguide portions and portions of the substrate material. Thus, in a waveguide with continuous taper, the taper changes its optical properties in a continuous and adiabatic fashion.

Waveguides with segmented tapers are capable of providing two-dimensional mode tapering. However, these waveguides typically are with high losses due to the multiple dielectric boundaries formed between the segmented waveguide portions. In addition, precise control of segmentation is technologically involved. Therefore, it can be appreciated that there is a need for systems and methods that address these and/or other shortcomings of the prior art.

The planar type optical devices can be made of various materials such as glass, semiconductors, amorphous silica and polymer. Ion Exchange (IE) and other ion diffusion techniques have been receiving increased attention as methods to produce channel optical waveguides in glass and other materials. The importance of the resulting channel glass waveguides stems from their compatibility with optical fibers, potentially low cost, low propagation losses and other factors. An example for the method of manufacturing the planar waveguide using the IE (Ion Exchange) method includes U.S. Pat. No. 4,913,717 (Apr. 3, 1990) entitled “Method for Fabricating Buried Waveguides, U.S. Pat. No. 5,035,734 (Jul. 31, 1991) entitled “Method of Producing Optical Waveguides”, U.S. Pat. No. 5,160,360 (Nov. 3, 1992) entitled “Process for Producing Low-loss Embedded Waveguide”, Strip Waveguides with Matched Refractive Index Profiles Fabricated by Ion Exchange in Glass (pp. 1966.about.1974 of ‘J. Appl. Phys’, 1991 by T. Poszner, G. Schreiter, R. Muller), Field-Assisted Ion Exchange in Glass: the Effect of Masking Film (pp. 1212.about.1214 of ‘Appl. Phys. Lett’, 1993 by B. Pantchev, P. Danesh, Z. Nikolov), and Polarization Insensitive Ion-Exchanged Arrayed-Waveguide Grating Multiplexers in Glass (pp. 279.about.298 of ‘Fiber and integrated optics’, 1998 by B. Buchold, C. Glingener, D. Culemann, E. Voges). A review of the Ion Exchange techniques is given by Ramaswamy et al., J. of Lightwave Technology, Vol. 6, No. 6, p.p. 984-1002, June 1998.

The method of manufacturing the planar waveguide using the Ion Exchange method, which was proposed by the patents and papers, can be summarized as follows:

The process is based on local changes in refractive index, which is achieved by replacing network modifiers from the glass with other ions at low temperature (below the strain point of the glass substrate). The exchanged ion in most cases is Sodium. The in-diffused ion may be another alkali metal (Lithium, Potassium, Rubidium, and Cesium) or another monovalent or divalent ion: Silver, Thallium or Copper. The most commonly used ions are Potassium and Silver. In the case of Potassium for Sodium IE the index change is induced mainly by stresses arising from the big differences in ionic radii, while in the case of Silver for Sodium IE the index change is due to the high polarizability of the Ag+ ion.

The source of the exchanging ions can be molten salt or a metallic layer deposited on the glass surface. The exchange can be performed either by thermal diffusion or by electro-migration. In order to achieve a high Δn upon IE, Silver for Sodium and Thallium for Sodium are preferable over alkali metal change. Another advantage of Silver IE is that stress free and hence Birefringence free products can be produced.

The Ion Exchange is occurred between a specific ion within the substrate glass (dominantly Na+ ions) and that within a salt solution containing specific ions (such as K+, Ag+, Cs+, Li+, Rb+, and Tl+ ions) when the glass surface between metal thin films called as a mask contacts with the salt solution. Based on this principle, a waveguide having high refractive indices is formed at predetermined portion of the substrate glass.

A typical diffusion process is exemplified by an Ion Exchange process wherein a piece of glass or another suitable material (a wafer) is contacted (e.g. immersed) with a melt containing desired ions. The ions of the melt, e.g. Ti+, Cs+, K+, Li+, Ag+, Rb+ ions, chosen to have a higher polarizability than the ones of the wafer, are exchanged with ions from the wafer, typically Na+. A review of the Ion Exchange techniques is given by Ramaswamy et al., J. of Lightwave Technology, Vol. 6, No. 6, p.p. 984-1002, June 1998. Generally, the techniques include depositing a metallic mask, with slots made e.g. by photolithography, on the glass substrate, contacting the substrate with melt containing selected cations, and, once surface waveguide(s) is produced by Ion Exchange and diffusion, optionally an application of electromagnetic field to force the cations below the surface to produce “buried” waveguides. The refractive index is locally increased in the substrate because of three factors: local change of the glass density, higher polarizability of the locally exchanged ions, and local stresses.

In more details, a surface of a glass substrate or another suitable material (a wafer) is initially masked by depositing a layer of masking material on a surface of the substrate, and photolithographic process of etching the layer of masking material, leaving openings where the waveguide path is to be formed. The masked surface is contacted by a first molten salt bath. In most cases, sodium ions in the substrate glass are exchanged for a doping cation such as Cs, Ag, Ru or Tl. An electrical field is sometimes applied during this first Ion Exchange process.

An alternative first Ion Exchange process: a surface of a glass substrate or another suitable material (a wafer) is initially masked by depositing a layer of pure metal or material that includes the donor (Silver) ions on a surface of the substrate, and photolithographic process of etching the layer of the suitable material, leaving it only where the waveguide path is to be formed. Ion Exchange process in which original (Sodium) ions in the glass are exchanged with donor (Silver) ions in the coating at high temperature by a diffusion process is following and electrical field is sometimes applied during this first Ion Exchange process.

The result of this first Ion Exchange process is usually a waveguide in the glass adjacent to the surface with relatively high Δn, relatively uniform Δn, relatively low thickness, and width according to the mask design.

The waveguide path can be buried under the substrate surface by removing the mask, applying external electric field across the substrate in an oven and contacting the active side with a second molten salt bath which contains ions that contribute less to the substrate refractive index, e.g. Na and K ions. Two effects contribute to this second Ion Exchange process—the burying process:
1. The electric field generates ionic current (current means ions electro migration) and the waveguide drifts (migrate, dragged) to deeper depth.
2. The current generates heat in the glass and in combination with the oven heat, the donor (silver) ions diffusion rates, cause waveguides swelling.

As a result of this double Ion Exchange process, there is formed beneath the first substrate surface a signal carrying region that has a higher refractive index than the region surrounding it, buried waveguides in the substrate with relatively low Δn, relatively high diameter and circular shape according to the process design.

U.S. Pat. No. 4,886,538 (Dec. 12 1989) entitled “Process for tapering waveguides” relates to a process for forming a channel waveguide in which the channel geometry and the channel index of refraction vary oppositely along the channel length to keep the modal characteristic of the channel uniform uses non-uniform heating of a channel waveguide to cause non-uniform diffusion of the channel doping ions. In one embodiment, the channel is passed under a laser at a non-uniform rate to expose the channel to different numbers of laser pulses.

U.S. Pat. No. 6,751,391 (Jun. 15, 2004) entitled “Optical systems incorporating waveguides and methods of manufacture” relates to an optical system that includes a substantially planar substrate and an elongate, two-dimensionally tapered waveguide channel at least partially buried in the substrate. It relates to a method for forming an optical system includes: providing a substrate; depositing on the substrate a contoured channel preform of material capable of Ion Exchange with the substrate; and diffusing ions from the channel preform into the substrate to form a waveguide channel at least partially buried in the substrate.

U.S. Pat. No. 6,769,274 (Aug. 3, 2004) entitled “Method of manufacturing a planar waveguide using Ion Exchange method” relates to a method of manufacturing the planar waveguide comprises three steps. The firs step is making a surface layer having a higher refractive index than that of glass substrate and a given thickness on a glass substrate by an Ion Exchange process; the second step is forming the pattern of the waveguide within the surface layer on the glass substrate; and the third step is coating a cladding layer on the entire surface including the waveguide. According to the process of the invention, a waveguide that is excellent in dimension control and reproducibility and has a sharp step wall can be produced.

The prior art methods and processes of tapering waveguides and of forming optimized waveguide structures are performed in a relatively complicated ways. Therefore, it can be appreciated that there is a need for methods and processes that address these and/or other shortcomings of the prior art.

### SUMMARY OF THE INVENTION

The present invention is directed to a method and process for forming a channel waveguide whose width and depth can be varied in any desired manner along its length, typically to taper in continuous fashion and adiabatic design from a relatively wide dimension to a relatively narrow dimension over a short length, and in which the index of refraction in the channel along such length varies in a manner to compensate for the change in geometry. As a result, the modal properties of the channel remain essentially uniform over the length.

In this process, the portion of the channel whose width and depth is to be controlled is subjected to non-uniform electric field along its length for a time and at a temperature such that there is effected along such length a prescribed non-uniform diffusion of the doping ions or impurity.

The electric field tends to diffuse the impurity outwards from the channel and increase its width and depth. Moreover, because the same amount of doping ions or impurity will merely have been spread over a wider waveguide volume, the increase in volume will have been compensated for by a corresponding decrease in the index of refraction.

Various ways are feasible for providing the desired non-uniform electric field. In a preferred embodiment, the local non-uniform electric field along the substrate length is maintained while the overall external electric field between the electrodes is fixed and constant along the substrate length.

Another object of the present invention is to improve the structure of an optical circuit and a waveguide optical amplifier.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic cross sectional description of electric field across substrate in an Ion Exchange process, according to some embodiments of the invention;

FIG. 2 is a schematic cross section of tapering device according to an embodiment of the present invention;

FIG. 3 is a schematic cross section description of tapering device along a longitudinal axis of waveguide, functioning according to some embodiments of the present invention;

FIG. 4 is a schematic cross section description of tapering device along a longitudinal axis of waveguide, functioning according to some embodiments of the present invention;

FIGS. 5A-5C are schematic cross section descriptions of a tapering device along a longitudinal axis of waveguide, functioning according to some embodiments of the present invention; and

FIG. 6 is a schematic cross sectional description of a coupling waveguide fabricated according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and devices have not been described in detail so as not to obscure the present invention.

It should be understood that the present invention may be used in a variety of applications. Although the scope of the present invention is not limited in this respect, the device and method disclosed herein may be used in many apparatuses such as in the opto-electronic devices, LASER Diodes, opto-diodes, fiber-optic, etc. Matching devices between laser diodes and single mode fiber, matching devices between single and multi mode fibers, focusing of large optical spot to small optical spot and so . . . ]. Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include device for performing the operation herein. This device may be specially constructed for the desired purposes, or it may be comprised a general-purpose apparatus or system.

In a uniform electric field (such as in, for example, an infinite, parallel plate capacitor):

E=V/d

Where E is the electric field strength, V is the voltage and d is the separation between the plates or electrodes.

In the case of Ion Exchange (IE) process the local internal electric field across the substrate is given by the same equation when d is the local substrate thickness and V is the voltage across the substrate between the two substrate interfaces with the conductive molten salt.

Reference is made now to FIG. 1, which is a schematic cross section description of internal electric field across substrate 16 in an Ion Exchange process, according to some embodiments of the invention. According to the depicted description by applying external electric field E by means of applying voltage V to electrodes 12 in touch with conductive material, such as molten salt 14, which are in touch with opposite faces of substrate 14, these faces in distance d from each other. Due to resulting electrical field E ions of substrate 16 are dragged inside the substrate 14 from position 17 to position 18 along arrows 19 and the waveguide initial core 17 is shaped from oval shape to circular 18 shape.

Based on the process described above, shape of a waveguide may be controlled to have desired shape or shapes along its longitudinal axis. Control of the magnitude of electrical field E may be achieved, according to some embodiments of the present invention, by defining the distance between the electrodes applying the electrical field to be non-constant as in FIG. 1.

### Wedged Substrate

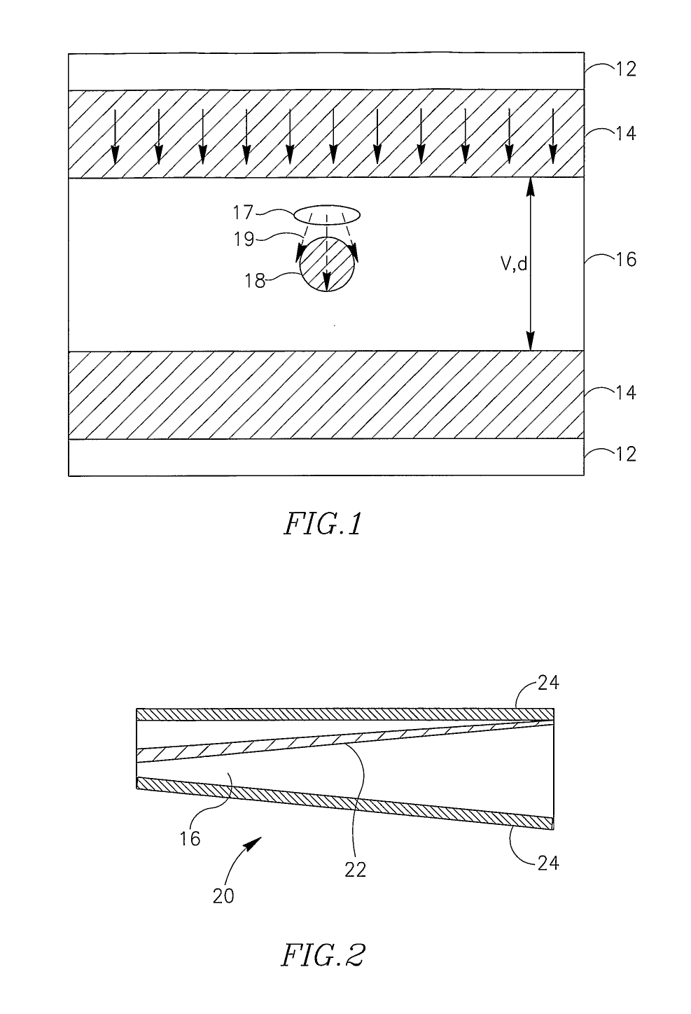

Reference is made now to FIG. 2, which is a schematic cross section of tapering device 20 along a longitudinal axis of waveguide 22, functioning according to an embodiment of the present invention. Initially, a core, initial waveguide may be formed in substrate 16 by burying a silver waveguide under linear gradient electric field Then, electrical field (not shown) may be applied to electrodes located on faces 24 of substrate 16 formed as a wedge so that the distance between faces 24 is linearly changing along substrate 16. Accordingly, the magnitude of the electrical field (aimed across substrate 16 from the upper electrode 24 to the lower electrode 24 in FIG. 2) changes linearly, being weaker close to the right side and stronger close to the left side of substrate 16 (FIG. 2). Due to the different magnitude of the electrical field along waveguide 16 the changes implied on the initial core shape (not shown) are weaker close to the right side of substrate 16 and stronger close to the left side of substrate 16, thus waveguide 22 may be tapered from left to right. Tapered waveguides are produced by burying the silver waveguides under linear gradient electric field. Under variable electric field conditions, two effects contribute to tapered waveguides:

1. High electric field generates higher ionic current followed by a deeper burial depth. (high current mean faster ion electro migration)
2. High current generates more heat in the glass, the silver ion diffusion rates elevate, cause more waveguides swelling.

As a result of the process, a tapered waveguide is produced, with small MFD (Mode Field Diameter) and shallow depth at one side (low electric field side), and high MFD and deep waveguide at the other side (high electric field side).

### Additional Dummy Wedged Substrate—Linear

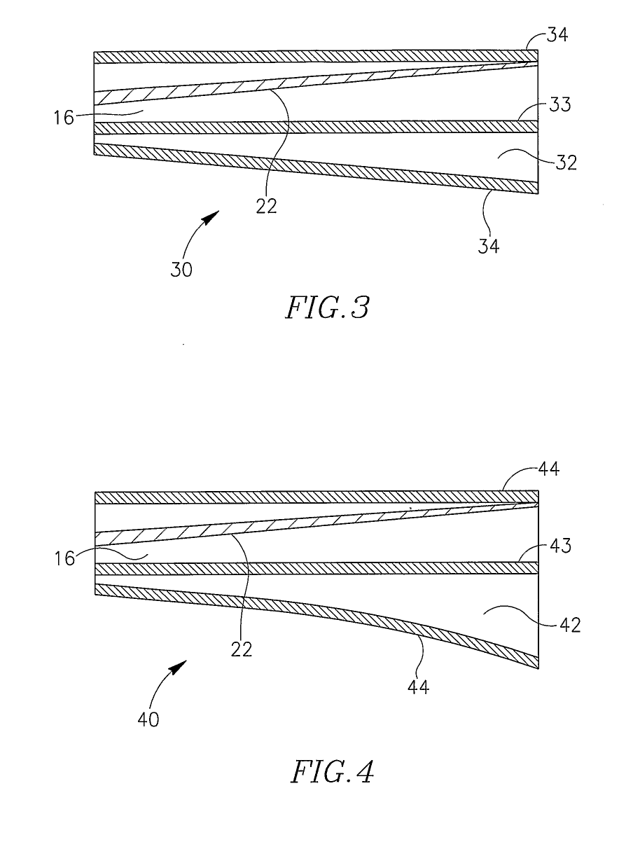

Reference is made now to FIG. 3, which is a schematic cross section description of tapering device 30 along a longitudinal axis of waveguide 22, functioning according to some embodiments of the present invention. In a way similar to that described with respect to FIG. 2, a wedge-like device 30 is constructed, yet here the gradually changing distance between the electrodes 34 is achieved by the attachment of a dummy wedge 32 next to face 33 of substrate 16. This brings to resulting electrical field similar to that described above with respect to FIG. 2.

### Additional Dummy Wedged Glass Substrate—Nonlinear

Reference is made now to FIG. 4 which is a schematic cross section description of tapering device 40 along a longitudinal axis of waveguide 22, functioning according to some embodiments of the present invention. In a way similar to that described with respect to FIGS. 2 and 3, a wedge-like device 40 is constructed, yet here the gradually changing distance between the electrodes 44 is achieved by the attachment of a dummy wedge 42 next to face 43 of substrate 16. In the example depicted in FIG. 4 the distance between electrodes 44 changes non-linearly, and the electrical field between these electrodes changes accordingly. As a result, the tapering of waveguide 22 may be non-linear.

### Additional Dummy Wedged Glass Substrate—Complex Linear or Curved Wedged Glass

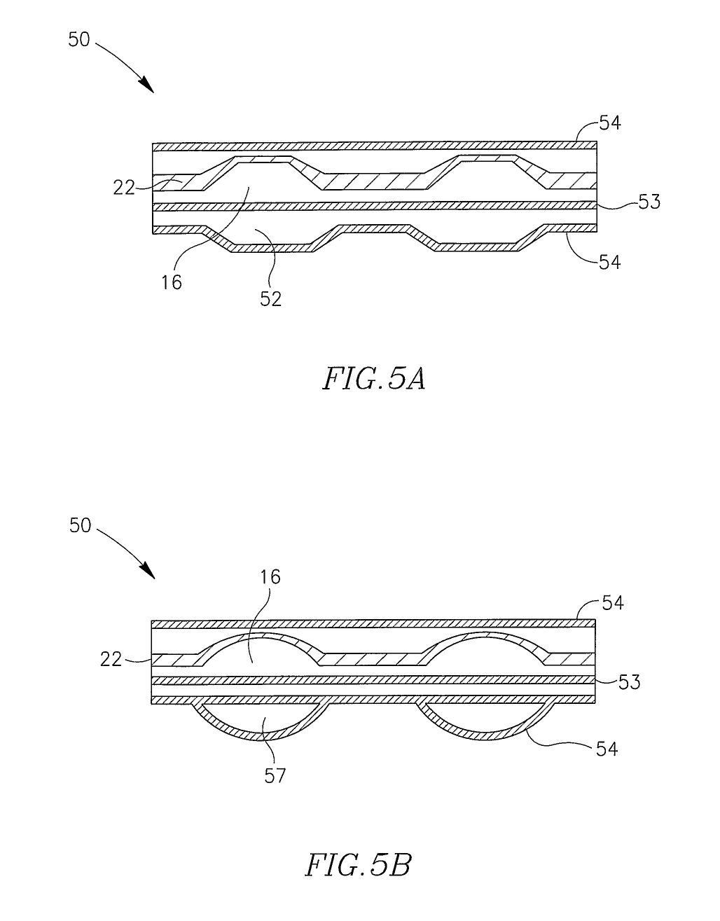

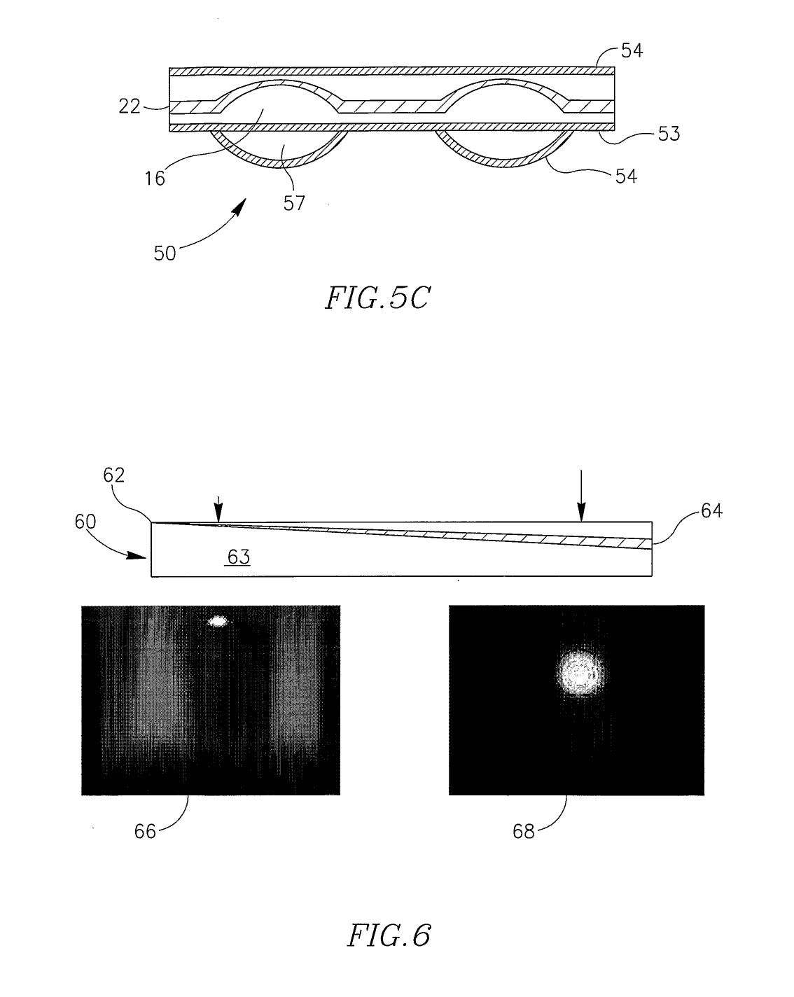

Reference is made now to FIGS. 5A 5B and 5C, which are schematic cross section descriptions of tapering device 50 along a longitudinal axis of waveguide 22, functioning according to some embodiments of the present invention. In a way similar to that described with respect to FIGS. 3 and 4, a device 50 is constructed, yet here the changing distance between the electrodes 54 is achieved by the attachment of a piece 52, 55, 57 respectively next to face 53 of substrate 16. Piece 52, 55, 57 may have complex linear or curved changing outer face. Accordingly, the distance between electrodes 54 complexly changes and thus may create a complexly tapered waveguide 22.

Reference is made now to FIG. 6, which is a schematic cross sectional description of a coupling waveguide that may be fabricated according to the some methods of the present invention described above, using the tapering process of the present invention. Waveguide 60 may have a first end 62 having a smaller, elliptical cross section and a second end 64 having a larger, substantially round cross section as depicted by views 66, 68 respectively. Waveguide 63 my be used, for example, as an adaptor, or an optical transformer, for connecting of, for example, a LASER diode to end 62 and an optical fiber to end 64. This arrangement enables simple, one-step production of conical taper for example, by unique control of stage two for example, with no additional production steps. This arrangement enables also the fabrication of an external mode size transformer that includes a waveguide having an input section, an output section, and a tapered section disposed between the input and output sections. The cross sections between the input and output sections of the waveguide can vary smoothly throughout the length of the waveguide. By positioning the external mode size transformer 60 between optical devices, coupling between optical devices is substantially improved compared to that of direct coupling. For example, by positioning the external mode size transformer between a laser and an optical fiber, laser to fiber coupling is significantly improved compared to that of direct coupling between these optical devices.

It would be apparent to a person skilled in the art that the methods and devices for manufacturing of waveguides described above are just examples. The same inventive solution may be used in many other ways, as long as electrical field is applied so as to form the required waveguide in a substrate.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for shaping an optical waveguide in a substrate comprising:
applying an electrical field across said substrate, said filed directed substantially perpendicularly to said waveguide to activate ion-exchange process on said waveguide; and
controlling the magnitude and duration of application of said electrical field to control the resulting change in cross-section of said waveguide.

2. The method of claim 1, wherein the magnitude of said electrical field controlled to gradually attenuate along said waveguide.

3. The method of claim 2, wherein said change in the magnitude of said electrical field is linear along said waveguide.

4. The method of claim 2, wherein said change in the magnitude of said electrical field is non-linear along said waveguide.

5. A device for shaping an optical waveguide in a material comprising:
a substrate comprising a waveguide formed in it in an initial shape;
an electrical field generator to apply a an electrical field across said substrate substantially perpendicular to said waveguide to activate ion-exchange process on said waveguide to change the initial cross-section of said waveguide proportional to the magnitude and duration of application of said electrical field;
control means to control the magnitude and duration of activation of said electrical field.

6. The device of claim 5 wherein said electrical field is applied to said substrate by means of electrodes positioned at two opposite sides of said substrate.

7. The device of claim 6, wherein said two opposite sides are substantially parallel to each other, to apply a homogenous electrical field along said waveguide.

8. The device of claim 6, wherein said two opposite sides are angled to each other, to apply a non-homogenous electrical field along said waveguide.

9. The device of claim 8, wherein the distance between said two opposite sides changes linearly along said waveguide to change the magnitude of said electrical field linearly along said waveguide.

10. The device of claim 8, wherein the distance between said two opposite sides changes non-linearly along said waveguide to change the magnitude of said electrical field non-linearly along said waveguide.
